(19) United States
(12) Patent Application Publication
(10) Pub. No.: US 2021/0179003 A1
(43) Pub. Date: Jun. 17, 2021

(54) AIRBAG DEVICE FOR PANORAMA ROOF

(71) Applicants: HYUNDAI MOBIS Co., Ltd., Seoul (KR); INALFA ROOF SYSTEMS KOREA LTD., Hwaseong-si (KR)

(72) Inventors: Byung Ho MIN, Yongin-si (KR); Dong Oh Lee, Yongin-si (KR); Kwang Won Seo, Seoul (KR); Sang Gi Jang, Pyeongtaek-si (KR)

(21) Appl. No.: 17/119,524

(22) Filed: Dec. 11, 2020

(30) Foreign Application Priority Data
Dec. 12, 2019 (KR) 10-2019-0165399

(51) Int. Cl. B60R 21/213; B60R 21/2334

(52) U.S. Cl. CPC B60R 21/213; B60R 2021/23192; B60R 21/2334

(57) ABSTRACT

An airbag device for a panorama roof including: a panorama roof; a blind disposed under the panorama roof, and configured to open/close the panorama roof; and a roof airbag embedded in a head liner, and deployed under the blind so as to cover the panorama roof

### CROSS-REFERENCE TO RELATED APPLICATION

This application claims priority from and the benefit of Korean Patent Application No. 10-2019-0165399, filed on Dec. 12, 2019, which is hereby incorporated by reference for all purposes as if set forth herein.

### BACKGROUND

### Field

Exemplary embodiments of the present disclosure relate to an airbag device for a panorama roof, and more particularly, to an airbag device for a panorama roof, which can reduce damage to a passenger, which occurs while the roof of a vehicle is damaged when the vehicle rolls over, prevent the passenger from being thrown out of a vehicle, and prevent a deployment error.

### Discussion of the Background

In general, a vehicle includes airbag devices installed for the safety of a driver or passengers. For example, the airbag devices are installed at the front, both sides and top of the vehicle. The airbag device includes an inflator and an airbag. When a predetermined magnitude of external impact is applied to the vehicle, gas generated by the inflator is injected into the airbag, and inflates the airbag. The airbag is rapidly inflated to protect the body of the passenger. When the vehicle rolls over, the airbag installed at the top of the vehicle is inflated. The airbag is unfolded toward the center from both sides of a panorama roof.

In the related art, however, the roof airbag of the vehicle is disposed between a blind and the panorama roof. Thus, when the blind covers the panorama roof, the airbag may be abnormally deployed because an airbag deployment space is insufficient. Therefore, there is a need for a device capable of solving the problem.

The above information disclosed in this Background section is only for enhancement of understanding of the background of the invention and, therefore, it may contain information that does not constitute prior art.

### SUMMARY

Exemplary embodiments of the present invention provide a safety alarm system and method for an airbag device for a panorama roof, which can reduce damage to a passenger, which occurs while the roof of a vehicle is damaged when the vehicle rolls over, prevent the passenger from being thrown out of a vehicle, and prevent a deployment error.

Additional features of the invention will be set forth in the description which follows, and in part will be apparent from the description, or may be learned by practice of the invention.

An exemplary embodiment of the present invention provides an airbag device for a panorama roof including: a panorama roof; a blind disposed under the panorama roof, and configured to open/close the panorama roof; and a roof airbag embedded in a head liner, and deployed under the blind so as to cover the panorama roof

The blind may include: a roll disposed under the panorama roof; a screen wound around the roll, and unwound from the roll so as to cover the panorama roof; and a blind shoe formed at an end of the screen.

The roll may be disposed at the rear of the panorama roof.

The roof airbag may include: an inflator disposed under the blind; a guide connected to the inflator and configured to guide gas; and a cushion connected to the guide, covered by the head liner, and deployed by gas guided through the guide so as to cover the panorama roof.

The inflator may include: a gas generation part connected to the guide, and configured to supply gas to the guide; and a gas fixation part configured to fix the gas generation part to the panorama roof.

The inflator may be disposed at the front of the panorama roof.

The cushion may include: a cushion deployment part disposed over an end of the head liner and folded before deployed; a cushion ring part disposed on either side of the cushion deployment part; and a cushion guide part disposed through the cushion ring part, and configured to guide the cushion ring part.

The cushion ring part may have both ends sewed to the cushion deployment part.

When the roof airbag is deployed, the head liner may be cut.

When the roof airbag is deployed, the head liner may be deformed so as to be bent.

In the airbag device for a panorama roof in accordance with an exemplary embodiment of the present disclosure, the roof airbag may be deployed under the blind, thereby preventing a deployment error caused by the blind. Furthermore, the roof airbag may be disposed at the front of the panorama roof, and the blind may be disposed at the rear of the panorama roof. Thus, the installation space for the parts may be secured to improve assembling performance.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram schematically illustrating an airbag device for a panorama roof in accordance with an embodiment of the present disclosure.

FIG. 2 is a diagram schematically illustrating an operation state of the airbag device for a panorama roof in accordance with the embodiment of the present disclosure.

FIG. 3 is a diagram schematically illustrating an inflator in the airbag device for a panorama roof in accordance with the embodiment of the present disclosure.

FIG. 4 is a diagram schematically illustrating a cushion in the airbag device for a panorama roof in accordance with the embodiment of the present disclosure.

### DETAILED DESCRIPTION OF THE ILLUSTRATED EMBODIMENTS

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Hereinafter, an airbag device for a panorama roof will be described below with reference to the accompanying drawings through various exemplary embodiments. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

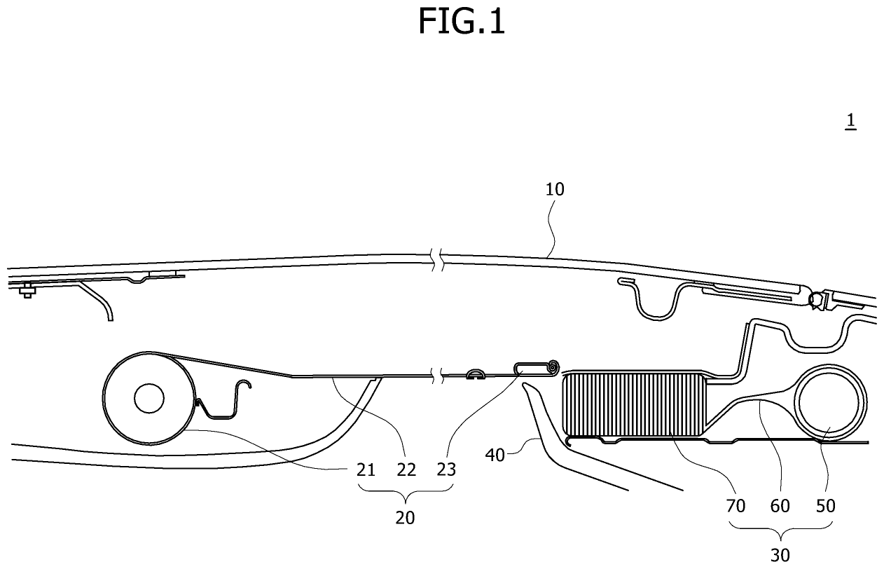

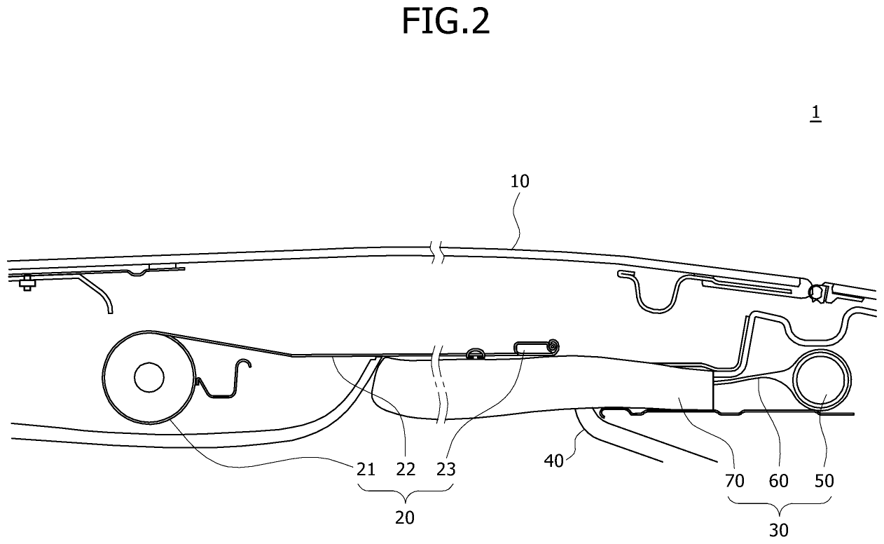

FIG. 1 is a diagram schematically illustrating an airbag device for a panorama roof in accordance with an embodiment of the present disclosure, and FIG. 2 is a diagram schematically illustrating an operation state of the airbag device for a panorama roof in accordance with the embodiment of the present disclosure. Referring to FIGS. 1 and 2, an airbag device 1 for a panorama roof in accordance with an embodiment of the present disclosure includes a panorama roof 10, a blind 20 and a roof airbag 30.

The panorama roof 10 is disposed at the ceiling of the vehicle. The panorama roof 10 may indicate a window composed of a first-row window and a second-row window, and the first-row window may be slid to provide a sense of openness.

The blind 20 is disposed under the panorama roof 10, and serves to open/close the panorama roof 10. For example, the blind 20 may include a roll 21 disposed at the rear of the panorama roof 10, a screen 22 wound around the roll 21 and unwound from the roll 21 so as to cover the panorama roof 10, and a blind shoe 23 formed at an end of the screen 22. The blind shoe 23 may be disposed at a front end of the screen 22, and the screen 22 may be manually or electrically moved to cover the first-row and second-row windows of the panorama roof 10.

The roof airbag 30 is embedded in a head liner 40, and deployed under the blind 20 so as to cover the panorama roof 10. For example, the head liner 40 may indicate an interior material within the vehicle, and serve to restrict the roll 21 and the roof airbag 30, which is not yet deployed, from being exposed to the outside. When the screen 22 covers the panorama roof 10, the blind shoe 23 may be covered by the head liner 40 having the roof airbag 30 embedded therein.

The roof airbag 30 in accordance with the embodiment of the present disclosure includes an inflator 50, a guide 60 and a cushion 70.

The inflator 50 is disposed under the blind 20. For example, the inflator 50 may be disposed at a lower level than the screen 22.

The guide 60 is connected to the inflator 50 so as to guide gas, and the cushion 70 is connected to the guide 60. The cushion 70 is covered by the head liner 40, and deployed by the gas guided through the guide 60 so as to cover the panorama roof 10. For example, the guide 60 and the cushion 70 may be formed as one body.

Thus, the gas jetted from the inflator 50 may pass through the guide 60, and deploy the cushion 70. At this time, the cushion 70 may be disposed adjacent to an end of the head liner 40, and thus rapidly cover the panorama roof 10.

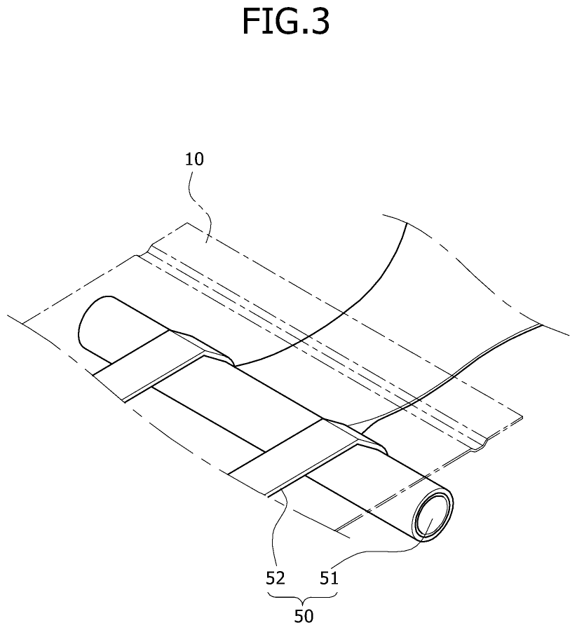

FIG. 3 is a diagram schematically illustrating the inflator in the airbag device for a panorama roof in accordance with the embodiment of the present disclosure. Referring to FIG. 3, the inflator 50 in accordance with the embodiment of the present disclosure includes a gas generation part 51 and a gas fixation part 52. Such an inflator 50 is disposed at the front of the panorama roof 10.

When receiving a vehicle collision signal, the gas generation part 51 is exploded to jet gas. The gas generation part 51 may have an inlet connected to the guide 60, and the guide 60 may be inflated by the jetted gas. For example, since the roll 21 is disposed at the rear of the panorama roof 10, the gas generation part 51 disposed at the front of the panorama roof 10 can secure a sufficient installation space.

The gas fixation part 52 fixes the gas generation part 51 to the panorama roof 10. For example, the gas fixation part 52 may be coupled to the outside of the gas generation part 51, and screwed to the bottom surface of a front end of the frame of the panorama roof 10. Alternatively, the gas fixation part 52 may be fixed to the vehicle body.

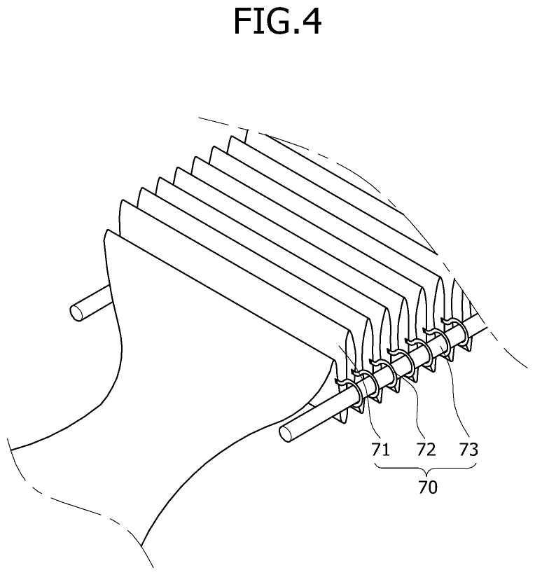

FIG. 4 is a diagram schematically illustrating the cushion in the airbag device for a panorama roof in accordance with the embodiment of the present disclosure. Referring to FIG. 4, the cushion 70 in accordance with the embodiment of the present disclosure includes a cushion deployment part 71, a cushion ring part 72 and a cushion guide part 73.

The cushion deployment part 71 is folded before deployed, and connected to the guide 60. The cushion deployment part 71 is disposed over an end of the head liner 40. For example, the cushion deployment part 71 may be disposed over the end of the head liner 40, and the blind shoe 23 may be disposed over the head liner 40 and the cushion deployment part 71.

The cushion ring part 72 is disposed on either side of the cushion deployment part 71. For example, the cushion ring part 72 may be formed of the same material as the cushion deployment part 71, and have both ends sewed to the cushion deployment part 71. The plurality of cushion ring parts 72 may be disposed in the longitudinal direction of the cushion deployment part 71.

The cushion guide part 73 is disposed through the cushion ring parts 72 so as to guide the cushion ring parts 72. For example, the cushion guide part 73 may be a rod which is formed to have a length in the deployment direction of the cushion deployment part 71, and has both ends coupled to the panorama roof 10 or the vehicle body. The cushion guide part 73 may be covered by the head liner 40, and restricted from being exposed.

The head liner 40 may be cut when the roof airbag 30 is deployed. That is, the head liner 40 may have a cutting line formed thereon. When the cushion deployment part 71 presses the head liner 40 from the inside to cut the head liner 40, the cushion deployment part 71 may be deployed through a space formed by the cutting of the head liner 40. In addition, the head liner 40 may be formed of a material which can be deformed by an external force. When the cushion deployment part 71 is deployed, the end of the head liner 40 may be deformed so as to be bent, and the cushion deployment part 71 may be deployed between the blind 20 and the head liner 40.

The operation of the airbag device for a panorama roof in accordance with the embodiment of the present disclosure, which has the above-described structure, will be schematically described as follows.

The roof airbag 30 is mounted at the front end of the panorama roof 10, and the blind 20 is mounted at the rear end of the panorama roof 10. Thus, the blind 20 may cover the panorama roof 10 while unfolded from the rear end of the panorama roof 10, and the roof airbag 30 may cover the panorama roof 10 while deployed from the front end of the panorama roof 10. At this time, since the roof airbag 30 is deployed under the blind 20, it is possible to prevent a deployment defect which may occur due to a narrow space, while the roof airbag 30 is deployed.

The guide 60 is connected to the inflator 50, and the folded cushion 70 is connected to an end of the guide 60. The cushion 70 may be covered by the head liner 40 so as not to be exposed to the outside.

When a vehicle accident occurs in the above-described state, the inflator 50 receiving a sensing signal is exploded to generate gas. The generated gas is moved through the guide 60, and supplied to the cushion deployment part 71. The cushion deployment part 71 is deployed by the supplied gas, and sequentially covers the first-row and second-row windows of the panorama roof 10, thereby protecting a passenger.

At this time, the guide 60 and the cushion deployment part 71 are disposed under the blind 20, and the cushion deployment part 71 passes through the head liner 40 or is deployed between the head liner 40 and the blind 20, which makes it possible to prevent a deployment error caused by the blind 20. Furthermore, since the head liner 40 supports the cushion deployment part 71 while the cushion deployment part 71 is deployed, it is possible to suppress the cushion deployment part 71 from drooping downward.

In the airbag device 1 for a panorama roof in accordance with the embodiment of the present disclosure, the roof airbag 30 may be deployed under the blind 20, thereby preventing a deployment error caused by the blind 20. Furthermore, the roof airbag 30 may be disposed at the front of the panorama roof 10, and the blind 20 may be disposed at the rear of the panorama roof 10. Thus, the installation space for the parts may be secured to improve assembling performance.

Although exemplary embodiments of the present disclosure have been shown and described hereinabove, the present disclosure is not limited to specific exemplary embodiments described above, but may be various modified by those skilled in the art to which the present disclosure pertains without departing from the scope and spirit of the disclosure as disclosed in the accompanying claims. In addition, such modifications should also be understood to fall within the scope and spirit of the present disclosure.

What is claimed is:

1. An airbag device for a panorama roof, comprising:
a panorama roof;
a blind disposed under the panorama roof, and configured to open/close the panorama roof; and
a roof airbag embedded in a head liner, and deployed under the blind so as to cover the panorama roof.

2. The airbag device of claim 1, wherein the blind comprises:
a roll disposed under the panorama roof;
a screen wound around the roll, and unwound from the roll so as to cover the panorama roof; and
a blind shoe formed at an end of the screen.

3. The airbag device of claim 2, wherein the roll is disposed at the rear of the panorama roof.

4. The airbag device of claim 1, wherein the roof airbag comprises:
an inflator disposed under the blind;
a guide connected to the inflator and configured to guide gas; and
a cushion connected to the guide, covered by the head liner, and configured to be deployed by gas guided through the guide so as to cover the panorama roof.

5. The airbag device of claim 4, wherein the inflator comprises:
a gas generation part connected to the guide, and configured to supply gas to the guide; and
a gas fixation part fixing the gas generation part to the panorama roof.

6. The airbag device of claim 4, wherein the inflator is disposed at the front of the panorama roof.

7. The airbag device of claim 4, wherein the cushion comprises:
a cushion deployment part disposed over an end of the head liner and folded before deployed;
a cushion ring part disposed on either side of the cushion deployment part; and
a cushion guide part disposed through the cushion ring part, and configured to guide the cushion ring part.

8. The airbag device of claim 7, wherein the cushion ring part has both ends sewed to the cushion deployment part.

9. The airbag device of claim 1, wherein, when the roof airbag is deployed, the head liner is cut.

10. The airbag device of claim 1, wherein, when the roof airbag is deployed, the head liner is deformed so as to be bent.
